(19) United States
(12) Patent Application Publication
(10) Pub. No.: US 2017/0105032 A1
(43) Pub. Date: Apr. 13, 2017

(54) System and Method for Cloud-based Broadcast Rights Management

(71) Applicants: William Davis, Raleigh, NC (US); Richard Kirk Owen, Raleigh, NC (US)

(72) Inventors: William Davis, Raleigh, NC (US); Richard Kirk Owen, Raleigh, NC (US)

(21) Appl. No.: 14/877,874

(22) Filed: Oct. 7, 2015

(51) Int. Cl. H04N 21/254; H04N 21/4627; H04N 21/258; H04N 21/84; G06F 17/30; H04N 7/16; H04N 21/4623

(52) U.S. Cl. CPC H04N 21/2541; H04N 7/162; H04N 21/4627; H04N 21/4623; H04N 21/84; G06F 17/30858; G06F 17/30817; H04N 21/25841

(57) ABSTRACT

A system and method for the management and maintenance of content delivery rights and the scope of content delivery rights for events in which the content may not be delivered to all areas in which the event content could be delivered. The system and method presents a visual view of a cloud-based “geographic truth” which presents a geographic representation of all geographic areas into which content delivery is to be suspended or blacked out. The system and method manages the definition, modification, and management of blacked out areas based upon input by stakeholders. Stakeholders have access to the geographic truth at any time and all changes and updates are made to a single site such that an up to date summary made be instantly viewed at any time.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Video and multimedia content providers derive income from the content they own or control by entering into licensing agreements with distributors, such as television broadcasters, who, in turn, distribute such content (directly or indirectly) to consumers. This delivery model is often complicated by the fact that the distribution agreements define the geographic area where the content may be distributed, on what devices the content may be viewed, and how and when the content may be delivered to consumers.

It is in the best interest of both content providers and content distributors to manage the location and timing of the content delivery to defined geographic areas carefully. Content providers and distributors may be subject to contractual penalties or other disincentives when the content delivery rights are not managed properly and content is provided to areas that should not be receiving the content. Managing content delivery to defined areas, within specified timeframes, and potentially subject to other constraints is a complex task for all content providers and distributors.

### BRIEF DESCRIPTION OF THE DRAWINGS

Certain illustrative embodiments illustrating the organization and method of operation, together with objects and advantages may be best understood by reference to the detailed description that follows taken in conjunction with the accompanying drawings in which:

FIG. 1 is a view of a Broadcast Rights Management (“BRM”) system diagram consistent with certain embodiments of the present invention.

FIG. 2 is a view of the data flow within the BRM system consistent with certain embodiments of the present invention.

FIG. 3 is a view of the creation and management of the rights truth within the BRM system consistent with certain embodiments of the present invention.

FIG. 4 is a screen shot view from the BRM system of a DMA map for geographic areas to be blacked out from a particular content broadcast or stream consistent with certain embodiments of the present invention.

FIG. 5 is a screen shot view from the BRM system of a summary list of blacked out DMAs for a particular content broadcast or stream consistent with certain embodiments of the present invention.

FIG. 6 is a screen shot view from the BRM system of blacked out areas by zip code for a particular content broadcast or stream consistent with certain embodiments of the present invention.

FIG. 7 is a screen shot view from the BRM system of a summary list of blacked out areas by zip code for a particular content broadcast or stream consistent with certain embodiments of the present invention.

FIG. 8 is a screen shot view from the BRM system of a GeoJSON representation of a rights truth for a particular blacked out content broadcast or stream consistent with certain embodiments of the present invention.

FIG. 9 is a screen shot view from the BRM system of a request to update the rights truth for a blacked out area for a particular content broadcast or stream consistent with certain embodiments of the present invention.

FIG. 10 is a screen shot view from the BRM system of the radius of a blacked out area for a particular content broadcast or stream consistent with certain embodiments of the present invention.

FIG. 11 is a screen shot view from the BRM system of a summary list of IRDs to be excluded from broadcasting particular content consistent with certain embodiments of the present invention.

FIG. 12 is a screen shot view from the BRM system of a summary list of blacked out DMAs for a particular content broadcast or stream presented to stakeholders consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “mobile device” refers to any device that can be easily moved from place to place such as, but not limited to, a smart phone, tablet, iPad, network computer, watch or any other device a stakeholder may carry when travelling from place to place and which interacts with one or more networks.

Reference throughout this document to an “integrated receiver/decoder” or “IRD” refers to any electronic device used to pick up a radio frequency signal and convert all information transmitted within the radio frequency signal to digital format.

Reference throughout this document to a “stakeholder” refers to any content owner, licensor, licensee, syndicator or other content provider that uses the BRM system.

Reference throughout this document to “rights truth” refers to a consolidated package of differentiated “truths” defining business, contractual, and device rule sets. These individual “truths” make up the rights truth as a whole and provide the rights definition, scope of rights information, delivery structures, encoding, measurement data, authorization data, and stakeholder access for each type of “truth” maintained by the BRM system and permit updating, tracking and delivery of content using one or more rule sets. The rights truth may encompass geographic, advertising, authorization, device or platform, network, and viewing truths either separately or in any combination as required to accept and process stakeholder requirements.

Reference throughout this document to “geographic truth” refers to a broadcast management geographical area that is developed utilizing a GeoJSON format for encoding geographic data structures which may also contain delivery specific data and decision structures for content delivery into a bounded geographic area.

Reference throughout this document to an “advertising truth” refers to the set of rules that enable timing and insertion of advertising into streamed or broadcast content.

Reference throughout this document to an “authorization truth” refers to the set of rules for granting permission to view content.

Reference throughout this document to a “device truth” refers to the set of rules for determining the devices to which content may be distributed.

Reference throughout this document to a “network truth” refers to the set of rules for determining network connections and channels over which content distribution may occur.

Reference throughout this document to a “viewing truth” refers to the set of rules for determining the channels and methods for viewing time delayed content.

Reference throughout this document to a “rights definition” refers to the output of the BRM system in response to a query about the scope of broadcast rights for particular content.

The BRM system has a database for the various aspects of broadcast rights for particular content, including areas of coverage, permitted devices and platforms, and timeframes. The main benefit of a cloud-based BRM system is the real time access by multiple stakeholders to a system that can update, modify, query and communicate about the status, including any moves, adds, and changes, of the broadcast rights for a distributed video event. In an initial implementation, and not by way of limitation, definitions of areas of coverage for sports networks may be created and maintained in the BRM system, although the rights for any other type of video event, such as concert events or other pay-per-view and live events, may be equally managed by the BRM system. The BRM system may permit selection of pre-defined or customized geographic areas for the determination of where particular content may be unavailable to viewers, or “blacked out”, based upon the scope of the license for that content. The rights definition, including scope definitions of the various rights truths, may be displayed in any granularity desired by the user of the system, down to a particular zip code or neighborhood, and the distributor can then control the delivery of the content on that basis.

The various parameters of broadcast rights are defined in the BRM system by content owners or licensees, who are all stakeholders with regard to the rights truth managed by the BRM system. A content owner, as a stakeholder, may log onto the BRM server and define what rights are controlled by specific licensees. Licensee rights could include, but are not limited to, a geographic area, a specific receiving device and a set time period. This is accomplished by the content owner selecting the content for which they are applying parameters and then using either a map or rights listings. A geographic area may also be created by placing a pin drop with a defined area in a visual display of a geographic area; for example, a pin could be dropped on a sporting event venue with a 15 mile defined radius. In this non-limiting example, the pin drop would define the central locus and the 15 mile radius around the pin would define the geographic scope of the license for that content.

In another non-limiting example, a sports network could define the rights to broadcast such sporting events to multiple broadcasters in contiguous or non-contiguous areas specified as blacked out or not blacked out based upon criteria developed by the sports network. After the rights truths have been defined for a particular event, they may be updated in real-time such that the sports network may change the boundaries of the area up to and even during the event being broadcast.

The rights definition for a content provider may also be used to determine any overlaps in service areas for additional content providers. The BRM system may provide a comparison service to review the scope of rights for two or more distributors to determine any overlaps in their service areas. This comparison service permits the early identification of problem areas for distributors in which there may be two or more content service feeds serving a single area. In these overlapping areas, there may be conflicts for distributors that can be quickly discovered. The information provided to each content owner or licensee that is a subscriber to the BRM system may permit resolution of content delivery rights issues more quickly and with less disruption to content delivery and management.

The BRM system provides stakeholders with an easy-to-use, graphical user interface (“GUI”). This GUI permits users of the system to have a clear visual representation of the rights definition for a given broadcast. This visual representation provides users of the system with a geographic truth as to whether broadcasters are in compliance with distribution agreements; for example, by showing with a distinct color or marking on a map any geographic area that is being covered by multiple distributors. Additionally, stakeholders may refine the geographic truth by utilizing the GUI to control the destination of programming and content for both cable and internet delivery by displaying maps that reflect a distributor's areas of control broken down by zip code, counties, Nielsen Designated Market Area (“DMA”) or polygonal GeoJSON data. These maps provide visual confirmation and higher confidence to stakeholders that the particular content is available where it should be available, and is being blocked or blacked out where it should not be available—all in real time.

In a non-limiting example, where a sports event is the content to be delivered, a sports broadcaster may be bound by distribution agreements that require the game to be blacked out in a particular geographical area unless the game has sold out in the arena, stadium, or other sporting venue in which it is being played. The rights definition for this sports event would be available to the sporting event content owners and broadcasters to permit visual verification that the sporting event is truly blacked out in the area specified in the distribution agreement for the content. Because content owners or licensees can update the geographic truth in real time, the sports broadcaster would know the moment the sporting event was sold out in the sports venue. At that point in time, the BRM system could permit the sporting event content to be shown in the formerly blacked out geographical area.

The BRM system is cloud-based which fosters greater control of changes and makes possible real-time updates and messaging to stakeholders, such as sports or other broadcasters, content owners, and all others having a vested interest in the management of content delivery to specific geographic areas.

As the traditional interface used for the reception of content that is intended for rebroadcasting, an integrated receiver/decoder (IRD) does not usually contain a connection to cloud-based systems. In an exemplary embodiment, the instant invention provides for a plug-in module that integrates with IRDs so that they can communicate with the BRM system to obtain the rights definition for particular content and automatically (rather than manually) turn on or off delivery of that content. The plug-in may analyze the particular service footprint of an IRD and compare the geographic boundaries of the service footprint against the geographic truth in the BRM system using GeoJSON parameters. The BRM system may then locate overlap points for each service provider for a specific piece of content. This table of overlap points permits the reporting of overlap and possible conflicts in blacked out service areas to distributors that use one or more IRDs. In this embodiment, the BRM system will know the service area of each device that distributes a signal and can show when devices are conflicting with other devices or distributors.

In an additional embodiment, the devices and network components that have a built in capability to access cloud-based software and may establish a two-way connection between the BRM system and devices that provide content delivery via the internet. Devices such as the Apple TV, Roku, and smart TV devices have this capability and may access the rights definition for certain content within the cloud. This BRM system capability will permit such devices to manage access rights to specific content as set out in the applicable rights definition by communicating directly from the device to the BRM system.

In an alternative embodiment, the BRM system may provide rights management services to theaters, smart phones, tablets, or internet computers through direct communication. The BRM system may provide the rights definition parameters and boundaries in formats that are understood and may be utilized by mobile devices, internet devices, or other connected devices yet to be deployed in the marketplace. The BRM system may provide updates and directives for broadcast rights management directly in the format appropriate for each device.

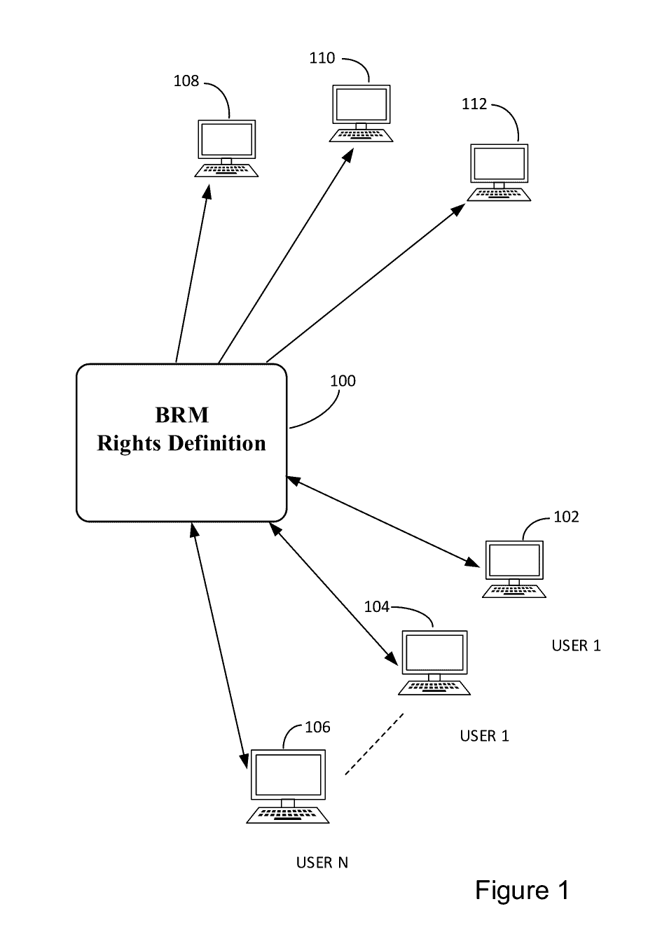

Turning now to FIG. 1, this figure presents a view of the BRM system consistent with certain embodiments of the present invention. In an exemplary embodiment, the BRM system consists of a cloud-based database 100 that contains the rights truths for a specific piece or series of pieces of content. Content stakeholders (102, 104, 106) may access the BRM system to define and/or update the rights truths for the content they control. Content distributors (108, 110, 112) may then access the BRM system to obtain a rights definition report of their distribution rights for that content based on the rights truths defined by the content owners or licensees.

The scheduling data for each content provider presents information about what events are scheduled for each day and time slot in an upcoming period of time. The upcoming period of time may be managed by the BRM system 100 as an open, integrated calendar, permitting the inclusion of scheduled events on the integrated calendar as they are finalized. The sales data for each content provider is presented to permit each content provider to determine specific geographic areas that will not receive the content (black out) for specific events based upon the geographic truth for that content. If a specific event in a venue in a particular geographic area is not fully sold out, the content provider may define the geographic truth for that event to exclude certain areas. As sales data for the event is updated, the geographic truth may also be updated so that blacked out areas may be reclassified as areas to be served and a fully sold out event may update the geographic truth so that the content is fully available to all geographic areas in proximity to the venue where the event is occurring.

In a non-limiting example, a content owner or licensee may classify a sporting event may be classified as being blacked out in a geographic area if the sporting arena is not fully sold out. in a non-limiting example, the BRM system database 100 may continue to track incoming sales data and modify the geographic truth for the event such that the geographic areas where the sporting event content may be broadcast can change in real-time with the level of sales of seats in the sporting arena. This tracking and updating may continue until all of the sporting arena's seats are sold, upon which time the geographic truth is updated for that sporting event. The content distributors (108, 110, 112) then receive updated rights definitions and can view the updated geographic truth for the content via the BRM system GUI.

The BRM system 100 may also provide access to the cloud-based rights definition database to distributors of particular content so such distributors can see what rights have been sold into each geographic area. To access the cloud-based rights definition database, a stakeholder 102, after authentication with the BRM system, may log into the cloud-based rights management database and review the defined geographic truths and other rights truths that are relevant to the stakeholder 102. The BRM system GUI presents a plurality of visual representations for the rights definition for a particular piece or series of pieces of content (including the geographic truth for such content) and permits the stakeholder 102 to access any of the visual representations that the stakeholder 102 may find useful in understanding the rights definition. For example, the stakeholder 102 may access an analysis of all geographic blackout requirements for a specific piece of content and then may access a geographic presentation of service area overlaps, conflicts, and gaps in broadcast coverage for that content. The stakeholder 102 may then update, modify, cancel, or delete parameters, such as adding new zip codes, canceling a blackout based upon selling out a venue, or modifying the geographic area to encompass more or less area. The stakeholder 102 may then transmit a message to the BRM system to indicate that changes to the rights truths within the database have been modified in some way. The BRM system may then process the updated data from the stakeholder 102 and update the data and the visual representation of the rights definition for that content. The BRM system may then transmit that message to a distributor of that specific content (108, 110, 112).

In an additional embodiment, another stakeholder 104, or additional stakeholders (up to stakeholder N 106), may also access the rights definitions for content associated with such stakeholder (104, 106). By the nature of a cloud-based system, each of these stakeholders (104, 106) may access the rights definition database simultaneously. The BRM system will update and manage all of the rights truths for each stakeholder (102, 104, 106) in real time. The BRM system, via the GUI, will provide an up to date visual representation for each stakeholder (102, 104, 106) for all content each such stakeholder controls.

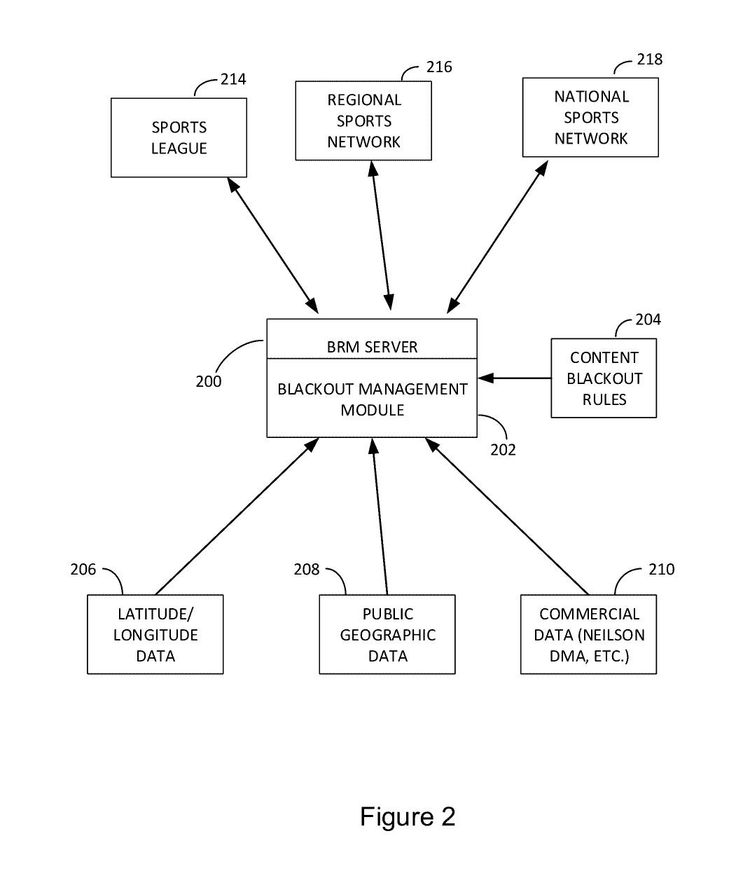

Turning now to FIG. 2, this figure presents a view of the data flow within the BRM system consistent with certain embodiments of the present invention. In an exemplary embodiment, the system includes a BRM server 200 upon which is stored and operating a number of software modules, of which one is a blackout management module 202. The BRM server 200 is in communication with one or more stakeholders. The stakeholders provide specific content blackout rules 204 to the BRM server 200 via the blackout management module 202.

In this exemplary embodiment, the BRM server 200 may store geographic information from input sources including, but not limited to, latitude and longitude data 206, geographic data supplied from government sources such as metropolitan area boundaries and zip code information 208, and commercial data such as DMA information 210. The BRM server then initiates the creation of specific rights definitions, which may be displayed via the GUI as one or more geographic truths, incorporating all geographic data input sources and the content blackout rules 204. The BRM system stores the geographic truths and rights definitions for each specific piece of content in a cloud-based storage area.

In this non-limiting exemplary embodiment, local sports league content stakeholders 214, regional sports network stakeholders 216 and national sports network stakeholders 218 may log in to accounts with the BRM system and access the cloud-based rights definition databases. Each of the stakeholders (214, 216, 218) may then update and modify their rights definitions for particular content on a real-time basis, and the geographic truth for that content is updated in real-time in response to such updates and changes.

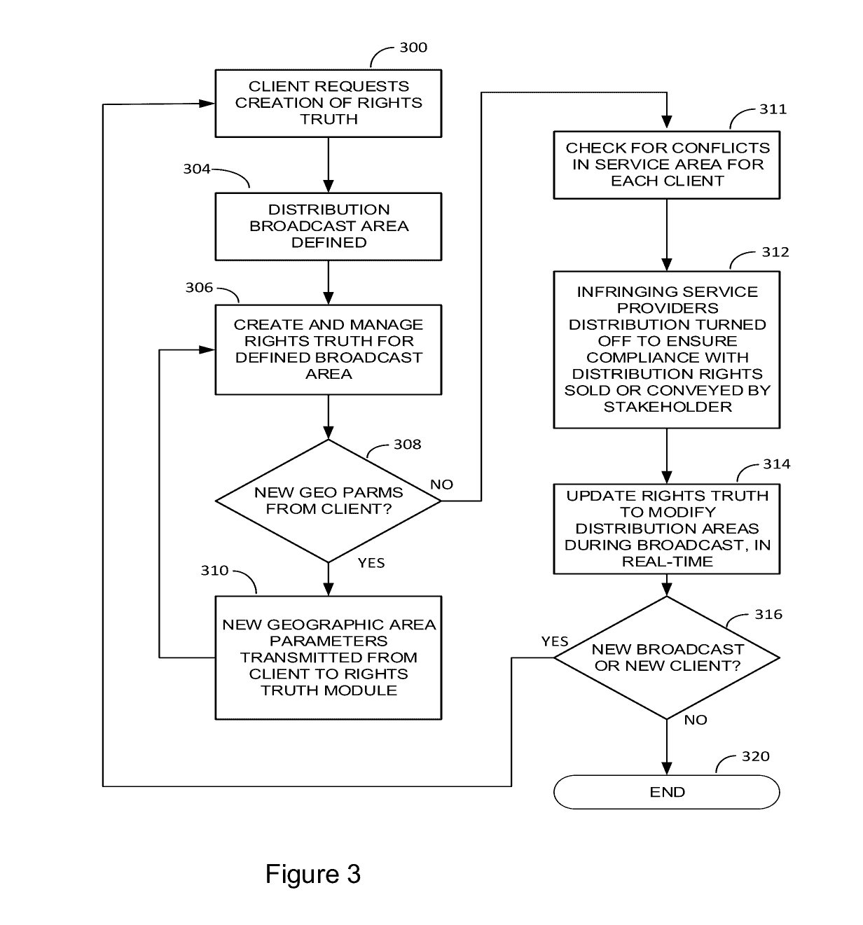

Turning now to FIG. 3, this figure presents a view of the creation and management of the rights truth within the BRM system consistent with certain embodiments of the present invention. In an exemplary embodiment, a content provider may want to create one or more specific aspects of the rights truth, such as, in non-limiting examples, a geographic truth, an advertising truth, a device truth, or other rights truth aspects. In a non-limiting example, a content stakeholder such as a sports league may create a rights truth 300 for a game between teams in Dallas and Chicago.

In this non-limiting example, each team in the sports league is allowed to enter distribution agreements with local TV stations that are in such team's market and internet distributors that permit access to the content within the team's market. The sports league has its own distribution agreements with cable TV networks where the content is delivered to homes throughout the country through a number of integrated receiver/decoders (IRDs) that are located within cable company headends around the country. Each IRD serves a specific distribution area and in this non-limiting example, the initial geographic parameter of the rights definition is defined using the IRD distribution areas 304. Based on this an initial rights truth is created 306.

As the Dallas and Chicago team stakeholders sell the distribution rights to the game, they log in to their accounts on the BRM system to inform the sports league that a local TV market has been sold for the game and needs to be removed from the sports league's distribution area 308. The sports league approves the local market sale 310 and a new rights truth for the game is created 306.

At any time, a stakeholder (lawyer, traffic personnel, operations manager, team owner, or salesperson) can log in to the BRM system and access the current geographic truth segment of the rights truth for the game that shows which local TV markets have been sold, approved or are pending based upon updated geographic parameters. The BRM system also permits a stakeholder to identify any potential conflicts that exist between the local TV market boundaries and the IRD distribution areas 311.

As game time draws near, the service providers which have rights for Internet (OTT) delivery of the game can access the geographic truth aspect of the rights truth to ensure that they are only sending the stream to viewers that are located in the area in which they have distribution rights. On the cable system, the map is checked for conflict areas and IRDs that are infringing on distribution rights that the local TV stations have purchased from the team stakeholders are turned off to ensure compliance 312.

If the game runs over its allotted time, the geographic parameters within the rights truth can be changed based on priorities and interests of the markets that were watching the game and that may wish to be transferred to other programming 314. The update may occur in real-time as the sporting event continues, permitting some markets to continue to receive the game and other markets to receive different programming based upon the contract distribution rights established for each geographic area by content stakeholders.

In another non-limiting example, there may be a conflict between a national broadcaster (ESPN) and a regional sports network (Comcast Philly) that share the rights to broadcast the game. Comcast Philly has a specific geographic-based market area that it serves and ESPN will have the rights to everything not covered by Comcast Philly. In the BRM system, Comcast Philly will create a geo-fence around their market area. Comcast Philly, based upon contract distribution rights maintained and managed in the rights truth, is required to keep their signal inside the geo-fence and ESPN is required to keep their signal outside the geo-fence 314.

In the exemplary embodiment, the BRM system may be operative to receive and process requests for additional rights truths from additional stakeholders, whether geographic, device related, or advertising related. Upon the receipt of a request for a modification to the rights truth, the BRM system once again defines and creates a rights truth for the stakeholder providing the request 314. If, however, there are no additional requests for rights truth creation or operation from stakeholders, the BRM system returns to wait mode 320.

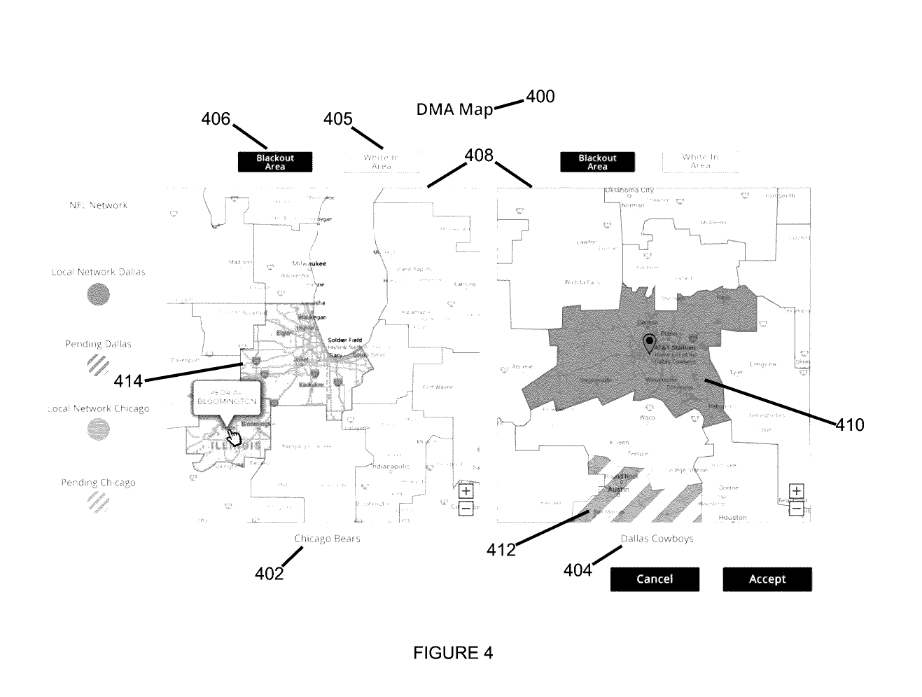

Turning now to FIG. 4, this figure presents a screen shot view from the BRM system of a DMA map showing geographic areas to be blacked out from a particular content broadcast or stream consistent with certain embodiments of the present invention. In an exemplary embodiment, upon logging in to the cloud-based BRM system and securing access to the rights definition for a particular event, a stakeholder may be presented with a visual display of the geographic truth for that particular event. In this non-limiting example, the event is a football game between the Chicago Bears and the Dallas Cowboys; however, the event could also be a concert, a pay-per-view event, or any other event where the broadcast of the event may be limited based upon distribution agreements for the event.

In this non-limiting example, the stakeholder has accessed the GUI display presenting a DMA map 400 for the Chicago market 402 and for the Dallas market 404. In this current view, the stakeholder is presented with maps of the designated markets (402, 404) containing visually distinct markings for areas in the markets where content can and cannot be broadcast. The shaded areas in the DMA maps provide the stakeholder with an instant assessment of the areas where the content will be broadcast 405, and the areas where the content will be blacked out 406 in accordance with the contractual arrangements between content owners and content broadcasters. The visual representations present geographic areas to be served by the National Football League (NFL Network) 408, by the local television station in Dallas 410, pending network broadcasts in Dallas 412, and the local television station in Chicago 414.

The stakeholder has the option to accept the screen view as presented, or to cancel the screen view. Accepting the presented view provides verification that the stakeholder agrees with the data presented. The selection of the cancel option may indicate that the stakeholder has completed their interaction with this display, or may be an edit request to remove or cancel updates that the stakeholder has input to the system.

It should be understood that this is just one manner in which the broadcast areas associated with a stakeholder or with a particular event may be represented. Additional content broadcasters, internet providers, or mobile content providers could be represented with additional shadings or demarked geographic areas, with overlapping areas represented by still further shadings or other indicators. Multiple events may also be represented on a single mapping screen based upon the stakeholder's request for event information to be displayed or integrated into a single view.

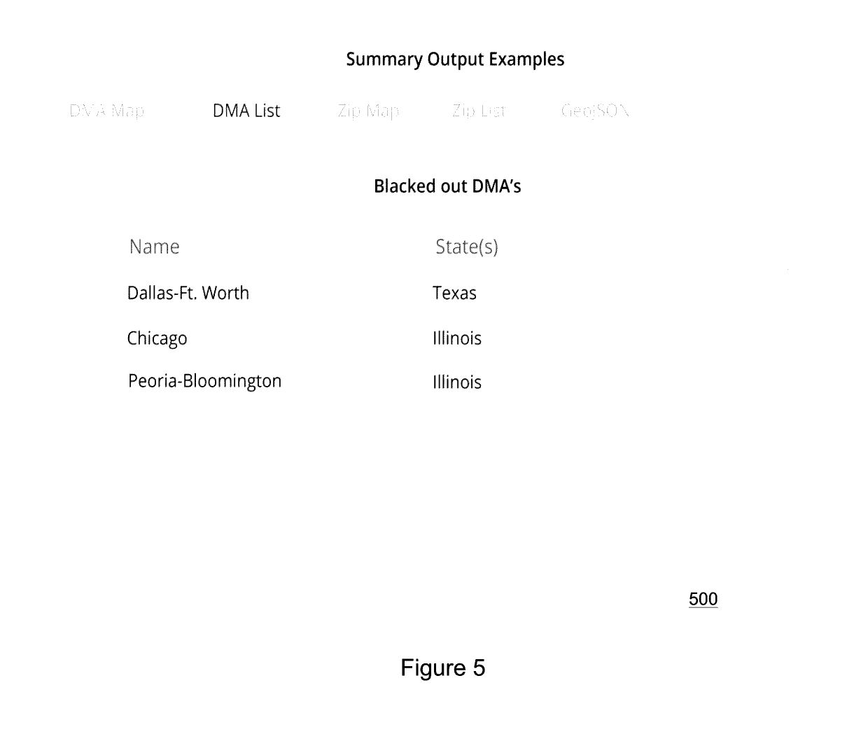

Turning now to FIG. 5, this figure presents a screen shot view from the BRM system of a summary list of blacked out DMAs for a particular content broadcast or stream consistent with certain embodiments of the present invention. In this embodiment, the visual representation of the broadcast areas presented to a stakeholder may consist of a list of known DMAs 500. This list may contain all geographic areas assigned to one or more DMAs based upon the Nielsen definitions, or may contain DMAs created under other standards or based upon custom defined market areas established in the BRM system. This screen shot provides information about the currently designated areas to be blacked out from the broadcast of specific content in a format the stakeholder may understand at a glance.

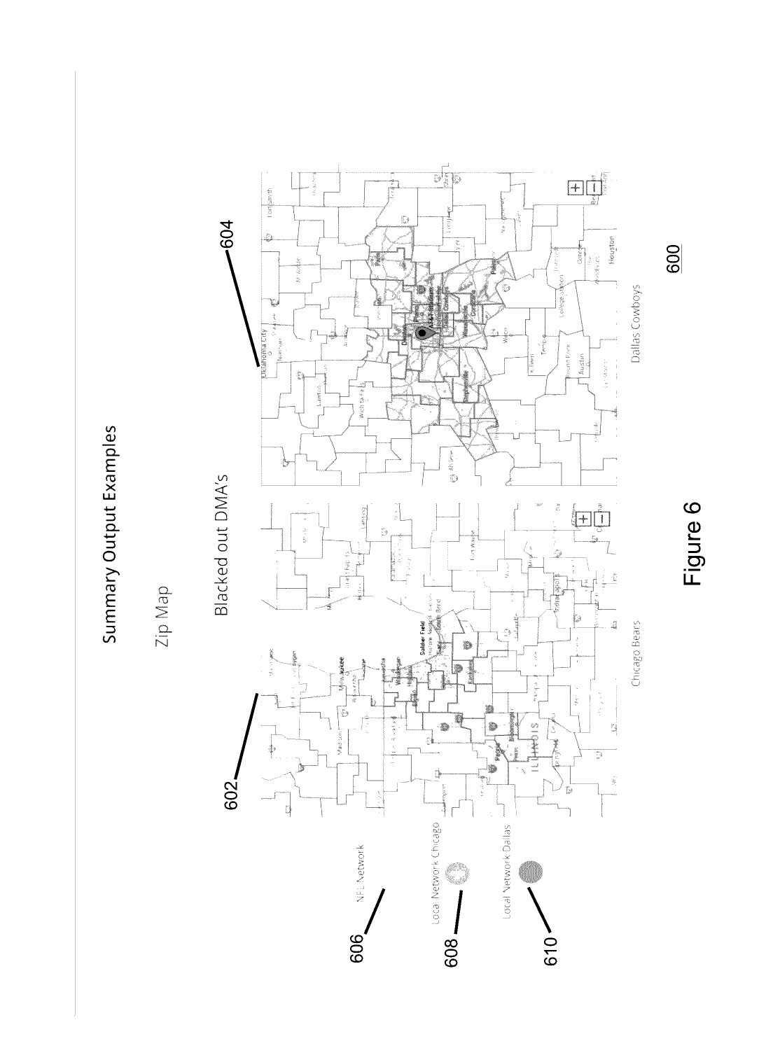

Turning now to FIG. 6, this figure presents a screen shot view from the BRM system of blacked out areas by zip code for a particular content broadcast or stream consistent with certain embodiments of the present invention. By way of example and not of limitation, this figure presents a screen shot of the GUI display for a particular broadcast event in which the market area for the broadcast is defined by zip code areas 600. Once again, in this non-limiting example, the broadcast event is a football game between the Chicago Bears and the Dallas Cowboys; however, the event could be a concert, a pay-per-view event, or any other event where broadcast may be limited based upon distribution agreements for the particular content.

The visual representation presents the stakeholder with geographic maps of the Chicago 602 and Dallas 604 areas to be served by broadcasters such as the NFL Network 606, the local Chicago Network 608, and the local Dallas Network 610. Shaded areas in the geographic map of Chicago and Dallas present a stakeholder with a visual indication of the current blacked out areas in both of the markets in which the sporting event content is to be broadcast on a zip code basis. This provides the stakeholder with a more granular view of the areas that are not being served with the current blackout instructions in place. Additionally, the stakeholder may have a better understanding of the geographic area if they are more conversant with zip code defined areas than areas defined by a Nielsen DMA. For any event in which content blackouts are to be maintained and managed these visual representations may provide a much faster understanding of the areas that are in blacked out status such that the stakeholder may make updates, modifications, or cancelations in a more timely fashion as additional sales and other information are presented to the stakeholder in real time. The stakeholder is thus capable of making decisions that will modify the blacked out areas both in the time leading up to the event and even during the broadcast of the event, as information indicating the change in status of any or all zip code areas is viewed by the stakeholder.

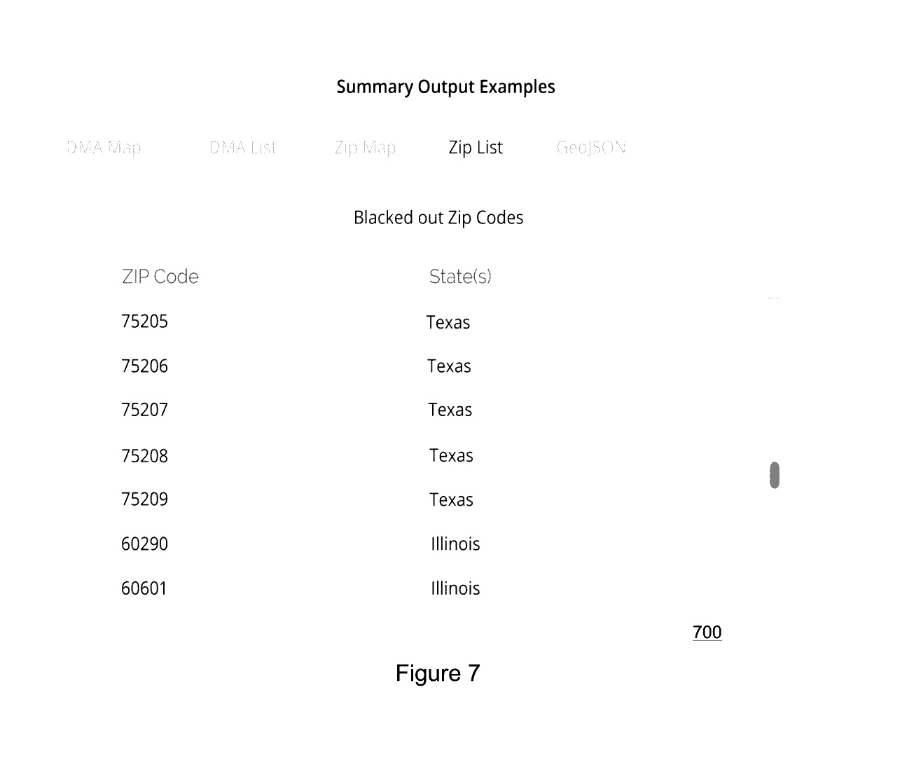

Turning now to FIG. 7, this figure presents a screen shot view from the BRM system of a summary list of blacked out areas by zip code for a particular content broadcast or stream consistent with certain embodiments of the present invention. In an exemplary embodiment, a stakeholder may prefer to review zip codes that are to be blacked out from delivery of particular content. A review of zip codes may provide a stakeholder with a more granular understanding of precisely what geographic areas are to be denied content delivery at a specified date and time. This figure presents a numerical listing of zip codes included in the blacked out geographic area 700. Stakeholders may compare this listing against other data, such as sales figures for the event to be broadcast, to determine with greater precision which areas are, or should continue to be, in the blacked out area. Stakeholders may also compare the zip code list against the map view, as presented in FIG. 6, to verify areas to be served and manage any updates to the service area.

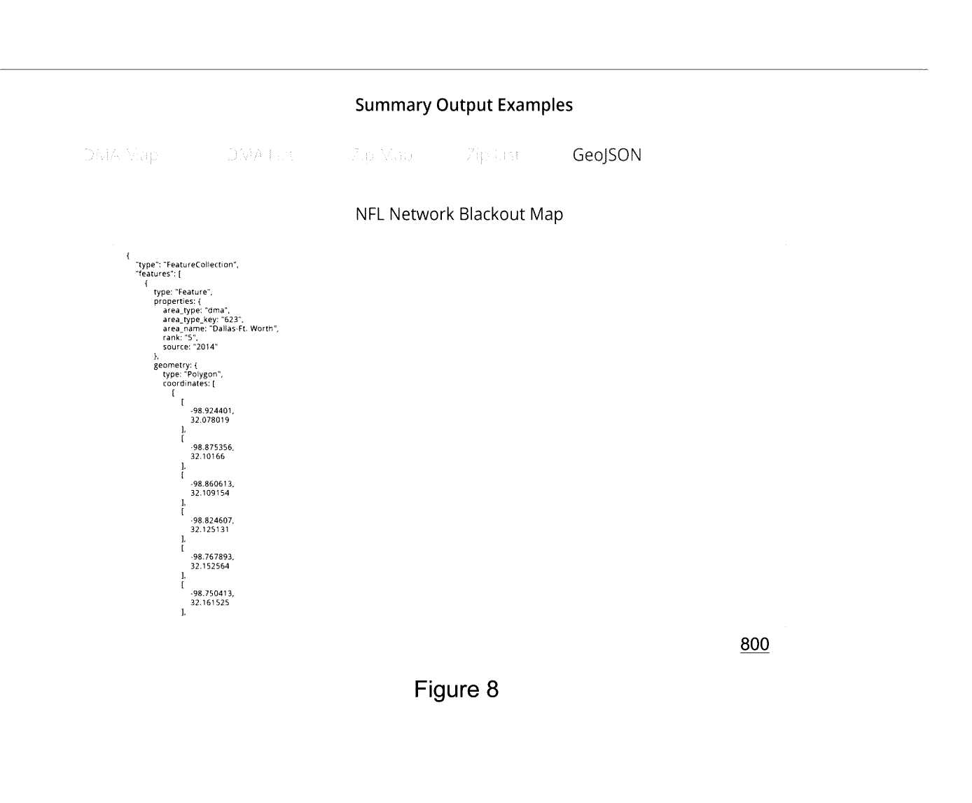

Turning now to FIG. 8, this figure presents a screen shot view from the BRM system of a GeoJSON representation of the geographic truth for a particular content broadcast or stream consistent with certain embodiments of the present invention. This figure presents coordinates of service areas to be managed by the BRM system that are coded in GeoJSON notation. This notation may be the preferred view of coders and other technicians, either working with the BRM system technical team or on staff at stakeholder locations. For errors in the visual view presented of the geographic truth, an adjustment of the GeoJSON coding may be required to correct one or more of the polygonal delimiters of areas in the boundaries of the geographic area represented by the GeoJSON coding. Correcting such inaccuracies may be most readily accomplished by accessing the GeoJSON coding and updating the coordinates directly which, in turn, may correct errors in the visual presentation of the geographic truth for particular content. This view may not necessarily be accessed by all stakeholders. The coordinates may be presented to all viewers, but are available for update and management only by authorized technical staff who have been granted edit access to the GeoJSON coordinate database.

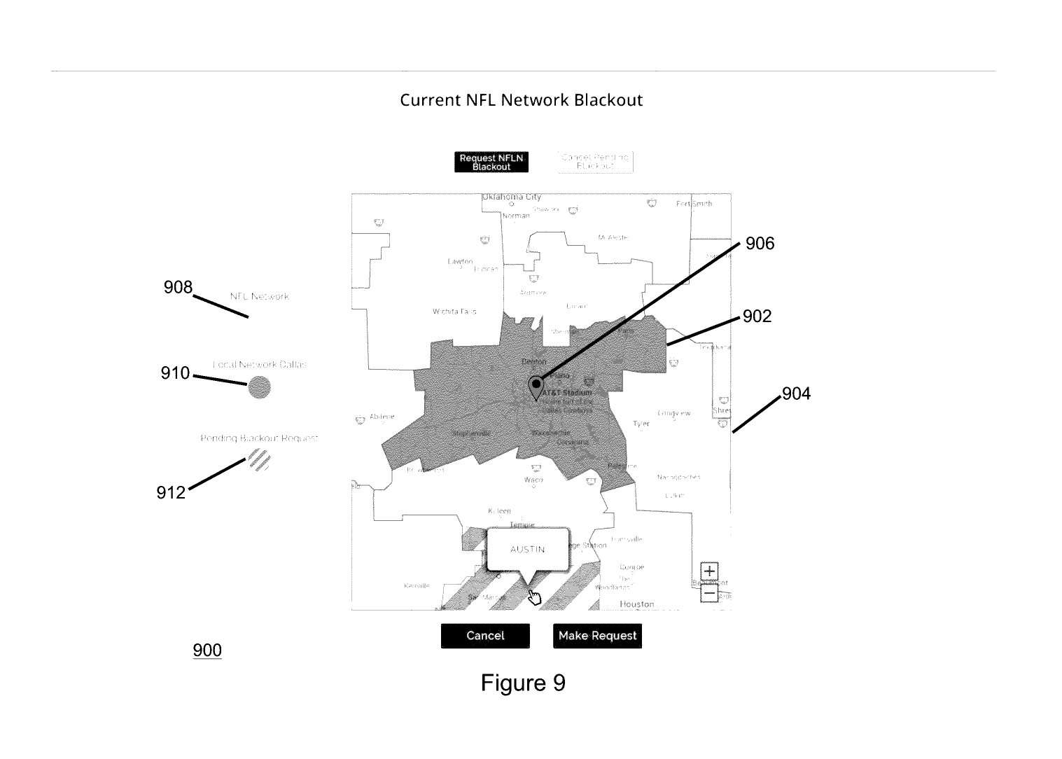

Turning now to FIG. 9, this figure presents a screen shot view from the BRM system of a request to update the geographic truth for a particular content broadcast or stream consistent with certain embodiments of the present invention. In an exemplary embodiment, stakeholders may request updates to the areas to be blacked out for particular content. This figure presents a visual representation, in the form of a map of a geographic area, of one such request.

In this exemplary embodiment, a stakeholder is presented with a visual representation of the geographic truth 902 for a specified event within a map of the general geographic area 904. In this non-limiting example, the content is an NFL football game and the stakeholder is shown the service area associated with the current NFL network blackout area 908, the service area associated with the local television station in Dallas 910 that is authorized to broadcast the game content, and a shaded area that represents a pending request for a geographic area to be blacked out 912. A stakeholder may once again determine at a glance the effect the pending blackout will have on the delivery or denial of delivery of the event content to specific geographic areas. Using this visual representation, a stakeholder may submit additional areas to be considered for blackout, may modify the pending request, or cancel the pending request. The request is then transmitted to the BRM server for consideration and verification prior to updating the cloud-based database containing the current parameters for blackout management of the specific geographic area.

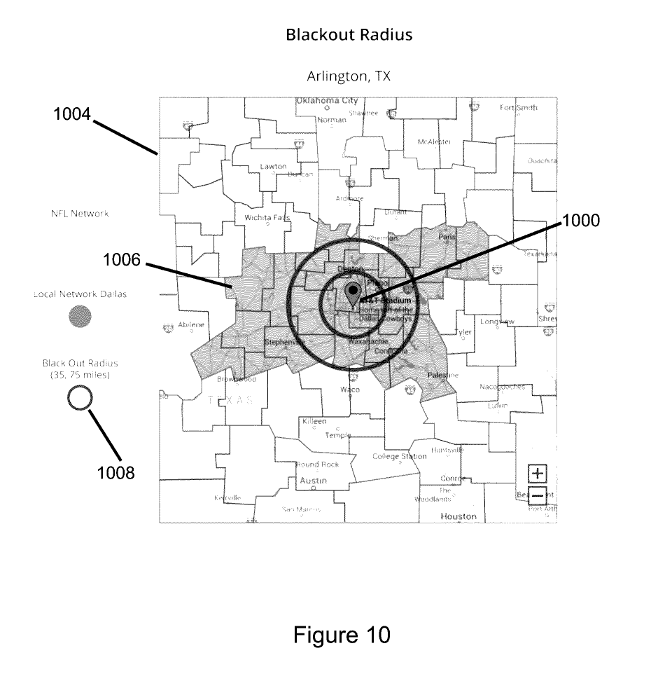

Turning now to FIG. 10, this figure presents a screen shot view from the BRM system of the radius of a blacked out area for a particular content broadcast or stream consistent with certain embodiments of the present invention. In this exemplary embodiment, a stakeholder is presented with a view of the geographic truth for particular content along with a pin drop that represents the physical location where the sporting event, concert event, or other event is to take place 1000. Additional contract conditions may dictate that certain areas be blacked out based on the location of the event (e.g., 35 miles from the stadium). Such contract terms may include provisions for updating the radius to be larger or smaller based upon sales figures, sponsorships, or other contract conditions that effect the dissemination of the event content.

In a non-limiting example, of an NFL football game, both the NFL network 1004 and a local Dallas television station 1006 have broadcast rights agreements with the Dallas Cowboys football team. The team may retain the right to restrict, or blackout, the broadcast of the game within a specified radius of the site of the event, the Dallas Cowboys stadium in Arlington, Tex. In this non-limiting example, the team may retain the right to restrict the blackout to a 75 mile radius or a 35 mile radius 1008 of the stadium based upon the number of seats that remain unsold prior to and during the game. This view presents how the radius parameters affect where a game may be shown and where it is, or will be, restricted based upon the defined blackout stipulations.

In this exemplary embodiment, all stakeholders may access the cloud-based BRM system and view the geographic truth for the game as the geographic view presented. Stakeholders with the proper authorization may update or make changes to the blackout requests or blackout areas in real-time as conditions change. All changes are processed by the BRM system such that all changes may be instantly seen by all stakeholders. In a non-limiting example, if a stakeholder with proper authorization were to shift the blackout radius from an existing 75 mile radius to a 35 mile radius because seats at the sporting venue are selling faster than expected, that update would be processed by the BRM server such that all stakeholders would see the update to a smaller radius at the same time.

Once again, it should be understood that this is just one manner in which the broadcast areas associated with a stakeholder or with a particular event may be represented. Additional content broadcasters, internet providers, or mobile content providers could be represented with additional shadings or demarked geographic areas, with overlapping areas represented by still further shadings or other indicators, or additional factors such as the radius from the event or other indicators that are of significance to stakeholders for each type of content. Multiple events may also be represented on a single mapping screen based upon the stakeholder's request for event information to be displayed or integrated into a single view.

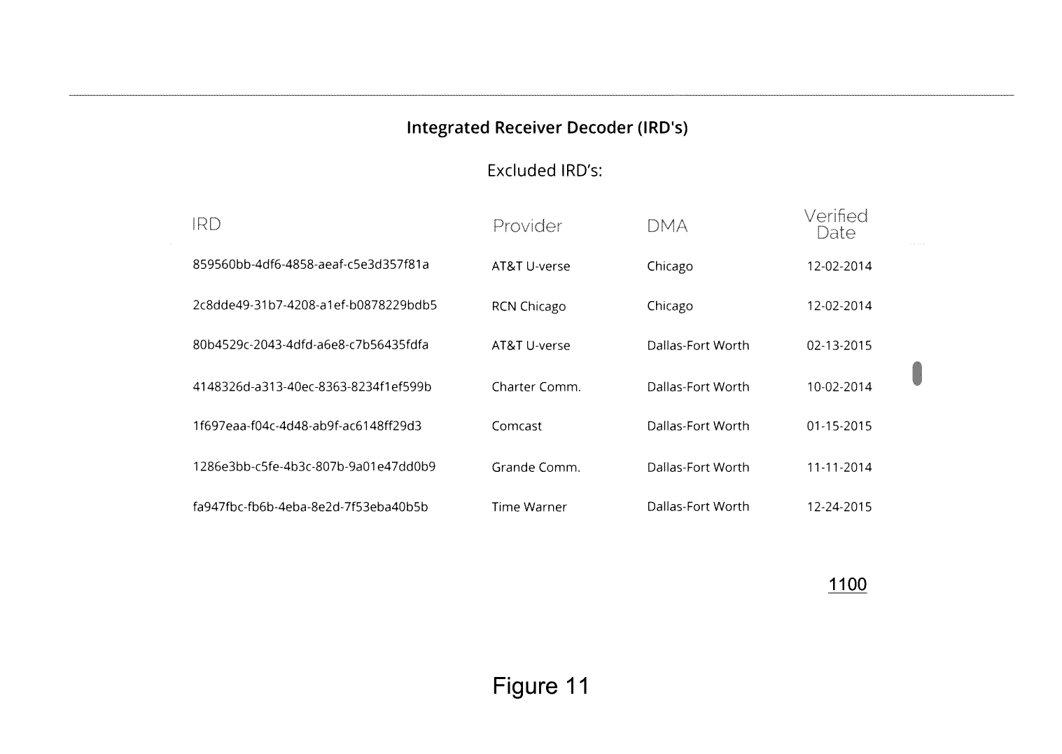

Turning now to FIG. 11, this figure presents a screen shot view from the BRM system of a summary list of IRDs to be excluded from broadcasting particular content consistent with certain embodiments of the present invention. In this embodiment, the BRM system may present a visual representation of all IRDs to which a stakeholder has authorized the event content be distributed 1100. This representation provides all stakeholders with an instant verification of whether contract rights are being honored, and also permits an instant view of any areas that are served by more than one content provider. With this information, the stakeholders may more readily address and minimize or eliminate areas of crossover and/or duplication in the presentation of the event content.

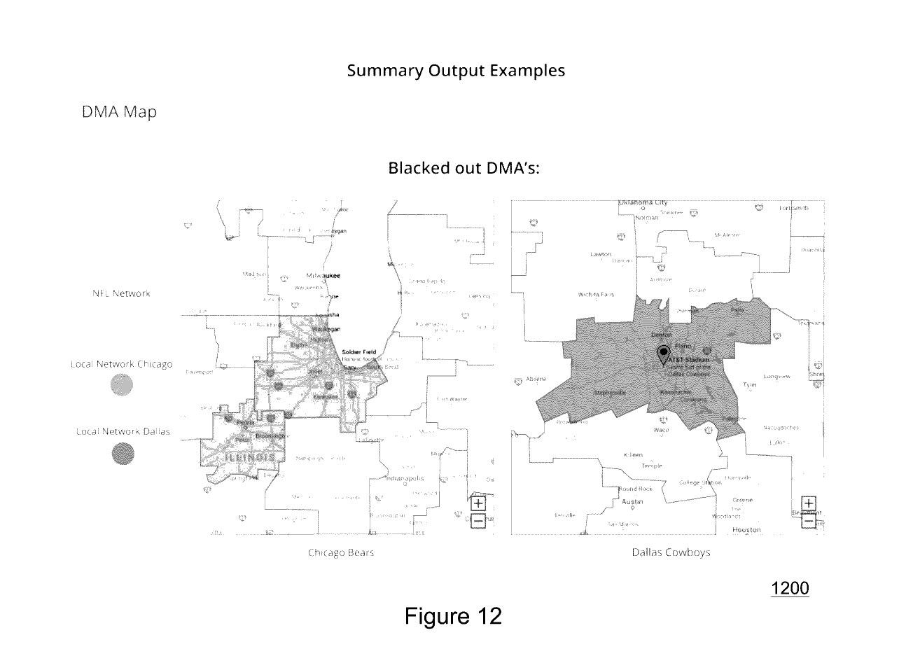

Turning now to FIG. 12, this figure presents a screen shot view from the BRM system of an output summary list of blacked out DMAs for a particular content broadcast or stream presented to clients consistent with certain embodiments of the present invention. In an embodiment, this figure presents a summary view of the current areas to be blacked out from the presentation of content for a specific event as an update to stakeholders 1200. All pending requests have been resolved and all areas into which contract rights have been sold are represented in a single visual representation. The geographic truth is updated for all stakeholders and managed in the cloud-based storage accessible by all stakeholders by the BRM system.

While certain illustrative embodiments have been described, it is evident that many alternatives, modifications, permutations and variations will become apparent to those skilled in the art in light of the foregoing description.

What is claimed is:

1. A method for managing content distribution rights, comprising:
provisioning a database system in cloud-based storage comprising content distribution rights definitions and one or more scope definitions of content distribution rights;
providing access to the database system to content stakeholders;
associating content distribution rights definitions and one or more scope definitions of content distribution rights with one or more content distributors in the database system;
transmitting the one or more scope definitions of content distribution rights from the database system relating to one or more items of content in one or more content delivery formats to content distributors who have secured the distributions rights for said one or more items of content;
providing an access interface to the database system for content distributors to permit a data connection from the database to said content distributor's content delivery mechanism; and
enabling delivery of content from the database system to said content distributor's content delivery mechanism based upon the content distributor's one or more scope definitions of content distribution rights.

2. The method of claim 1, further comprising a geographic truth that is a broadcast management geographical area developed and defined utilizing a GeoJSON format for encoding geographic data structures.

3. The method of claim 1, where the scope definition of content distribution rights comprises rights to utilize audio, video, text, visual cues, hypertext, close-caption data, and any other data format utilized to deliver content pertaining to an event of interest to customers.

4. The method of claim 1, where managing the delivery of multimedia content comprises the non-delivery of content to a geographic area in which the multimedia content is to be “blacked out”.

5. The method of claim 1, where managing the delivery of multimedia content further comprises updating the geographic areas within the geographic truth in which content is not to be delivered in response to stakeholder data input, where stakeholder is a content owner, licensee, licensor, or other party with an ownership interest in said multimedia content.

6. The method of claim 1, where managing the delivery of multimedia content further comprises checking the geographic truth for areas in which more than one content provider is providing content and resolving conflicts arising from such content delivery by multiple content providers.

7. The method of claim 5, where stakeholder input includes providing access to the content distribution rights database and permitting any stakeholder to add, update, modify, cancel, or otherwise edit content distribution rights to any content associated with said stakeholder.

8. The method of claim 1, where modifying the delivery of multimedia content for events based upon the modified geographic truth further comprises enlarging the geographic area for non-delivery of multimedia content, reducing the geographic area for non-delivery of multimedia content, defining devices to which the multimedia content is to be delivered, or delivering multimedia content to the entire geographic area.

9. The method of claim 1, where an event comprises a sporting event, a musical performance event, a pay-per-view event, a concert event, a staged performance event, or any other special event for which customers may be restricted from access based upon a required payment to receive the broadcast multimedia content for each such event.

10. A system for managing content delivery, comprising:
a server having a processor operative to access a database system in cloud-based storage comprising content distribution rights definitions and one or more scope definitions of content distribution rights;
a software module operative to provide access to the database system to content stakeholders to review, add or modify the content distribution rights definitions and/or the scope definitions of content distribution rights;
a software module operative to associate content distribution rights definitions and one or more scope definitions of content distribution rights with one or more content distributors in the database system;
a software module operative to transmit the one or more scope definitions of content distribution rights from the database system relating to one or more items of content in one or more content delivery formats to content distributors who have secured the distribution rights for said one or more items of content;
a software module operative to provide an access interface to the database system for content distributors to permit a data connection from the database to said content distributor's content delivery mechanism; and
a software module enabling delivery of content from the database system to said content distributor's content delivery mechanism based upon the content distributor's one or more scope definitions of content distribution rights.

11. The system of claim 10, further comprising a geographic truth that is a broadcast management geographical area developed and defined utilizing a GeoJSON format for encoding geographic data structures.

12. The system of claim 10, where the scope definition of content distribution rights comprises rights to utilize audio, video, text, visual cues, hypertext, close-caption data, and any other data format utilized to deliver content pertaining to an event of interest to customers.

13. The system of claim 10, where managing the delivery of multimedia content comprises the non-delivery of content to a geographic area in which the multimedia content is to be “blacked out”.

14. The system of claim 10, where managing the delivery of multimedia content further comprises updating the geographic areas within the geographic truth in which content is not to be delivered in response to stakeholder data input, where stakeholder is a content owner, licensee, licensor, or other party with an ownership interest in said multimedia content.

15. The system of claim 10, where managing the delivery of multimedia content further comprises checking the geographic truth for areas in which more than one content provider is providing content and resolving conflicts arising from such content delivery by multiple content providers.

16. The system of claim 14, where updating the geographic areas within the geographic truth occurs in real-time.

17. The system of claim 10, where modifying the delivery of multimedia content for events based upon the modified geographic truth further comprises enlarging the geographic area for non-delivery of multimedia content, reducing the geographic area for non-delivery of multimedia content, or delivering multimedia content to the entire geographic truth.

18. The system of claim 10, where an event comprises a sporting event, a musical performance event, a pay-per-view event, a concert event, a staged performance event, or any other special event for which customers may be restricted from access based upon a required payment to receive the multimedia content for each such event.
